(19) United States
(12) Patent Application Publication
(10) Pub. No.: US 2018/0054674 A1
(43) Pub. Date: Feb. 22, 2018

(54) PORTABLE NOISE MEASURING DEVICE AND NOISE MEASURING METHOD

(71) Applicant: HYUNDAI MOTOR COMPANY, Seoul (KR)

(72) Inventors: Sung Gyoo CHOI, Suwon-si (KR); Sung Uk CHOI, Hwaseong-si (KR); Se Min MOON, Hwaseong-si (KR); Young Key KIM, Daejeon (KR); Ki Ho JANG, Daejeon (KR)

(21) Appl. No.: 15/369,553

(22) Filed: Dec. 5, 2016

(30) Foreign Application Priority Data
Aug. 19, 2016 (KR) 10-2016-0105672

(51) Int. Cl. H04R 1/46; G01N 3/06

(52) U.S. Cl. CPC H04R 1/46; G01N 2203/0658; G01N 2203/0062; G01N 3/06

(57) ABSTRACT

A portable noise measuring device includes: a head part disposed at a front end of a body part and applying a pressure to an external object; a microphone disposed inside the body part and measuring noise; and an output part mounted on an outside surface of the body part and displaying a level of the noise measured by the microphone.

### CROSS-REFERENCE TO RELATED APPLICATION

This application claims the benefit of priority to Korean Patent Application No. 10-2016-0105672, filed on Aug. 19, 2016 in the Korean Intellectual Property Office, the entire disclosure of which is incorporated herein by reference.

### TECHNICAL FIELD

The present disclosure relates to a portable noise measuring device and a noise measuring method, and more particularly, to a portable noise measuring device and a noise measuring method for detecting noise sources of components mounted inside and outside a vehicle by measuring noise generated in the corresponding components.

### BACKGROUND

Generally, noise is generated due to friction between components of a vehicle body, caused by deformation of vehicle components while driving a vehicle on a road after assembly of interior components and exterior components of the vehicle is completed. Such deformation may be owing to a defect at the time of assembling the interior and exterior components on a vehicle production line.

Workers typically evaluate whether or not noise is generated by directly pressing assembled portions with their hands in order to detect a defect state at the time of assembling the interior and exterior components of the vehicle. However, methods and strengths of pressing the components are different from each other for each worker, such that reliability for a noise measuring result is low.

### SUMMARY

The present disclosure has been made to solve the above-mentioned problems occurring in the prior art while advantages achieved by the prior art are maintained intact.

An aspect of the present disclosure provides a portable noise measuring device and a noise measuring method for detecting noise sources of components mounted inside and outside a vehicle by measuring noise generated in the corresponding components.

According to an exemplary embodiment in the present disclosure, a portable noise measuring device includes: a head part disposed at a front end of a body part and applying a pressure to an external object; a microphone disposed inside the body part and measuring noise; and an output part mounted to an outside surface of the body part and displaying a level of the noise measured by the microphone.

The microphone may interwork with the head part such that the microphone measures the noise generated when the head part applies the pressure to the external object.

The body part may include a shock absorber interworking with the head part to absorb shock generated when the head part applies the pressure to the external object.

The body part may include a load cell interworking with the shock absorber to measure a pressure depending on a pressing level of the external object.

The load cell may interwork with the output part to allow the measured pressure to be displayed on the output part.

An integrated board may interwork with the load cell and the microphone to store a measured history therein.

The body part may include a handle formed in a downward direction and having a knob shape.

The integrated board may be provided in the handle, and a connector may be formed at a lower portion of the handle to connect the integrated board to an external computer.

The head part may be provided to be detachable from the body part.

The head part may be formed of a flexible plastic material in order to prevent generation of damage at the time of pressing the external object.

According to another exemplary embodiment of the present disclosure, a noise measuring method includes: a first step of applying a pressure to an external object through a head part of a body part; a second step of measuring the noise generated in the external object through a microphone provided in the body part when the head part applies the pressure to the external object; and a third step of displaying a level of the noise measured from the microphone on an output part of the body part after the second step.

In the third step, the body part may be connected to an external computer through a connector to allow the level of the noise measured from the microphone to be confirmed through the external computer.

### BRIEF DESCRIPTION OF THE DRAWINGS

The above and other objects, features and advantages of the present disclosure will be more apparent from the following detailed description taken in conjunction with the accompanying drawings.

FIG. 1 is a view illustrating a portable noise measuring device according to an exemplary embodiment in the present disclosure.

FIG. 2 is a view illustrating a noise measurement target using the portable noise measuring device according to an exemplary embodiment in the present disclosure.

FIG. 3 is a view illustrating an example of the portable noise measuring device according to an exemplary embodiment in the present disclosure.

FIG. 4 is a view illustrating a head part and an internal configuration of a handle of the portable noise measuring device according to an exemplary embodiment in the present disclosure.

FIG. 5 is a view illustrating an example of a measurement result at the time of connecting the portable noise measuring device according to an exemplary embodiment in the present disclosure and a computer to each other.

FIG. 6 is a flow chart illustrating a noise measuring method according to an exemplary embodiment in the present disclosure.

### DETAILED DESCRIPTION

Exemplary embodiments of the present disclosure will be described in detail with reference to the accompanying drawings.

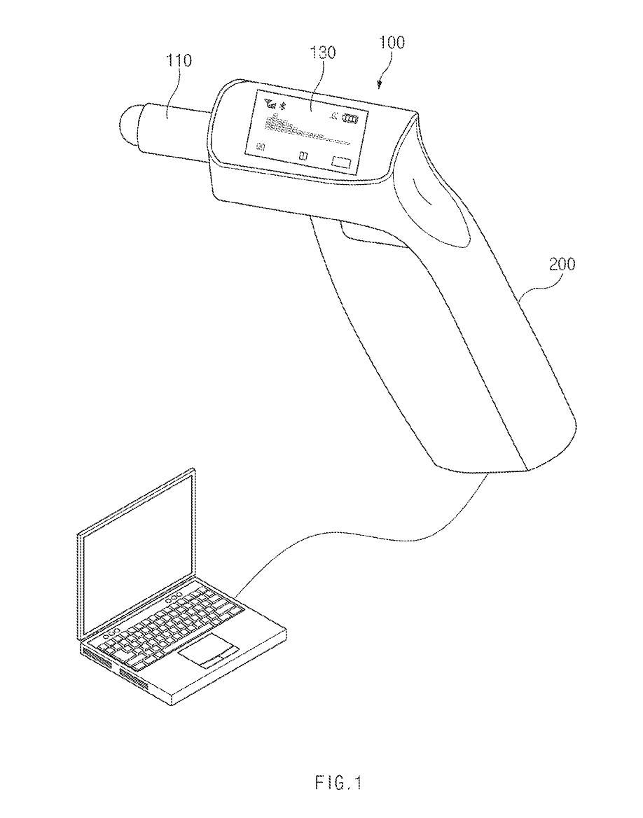

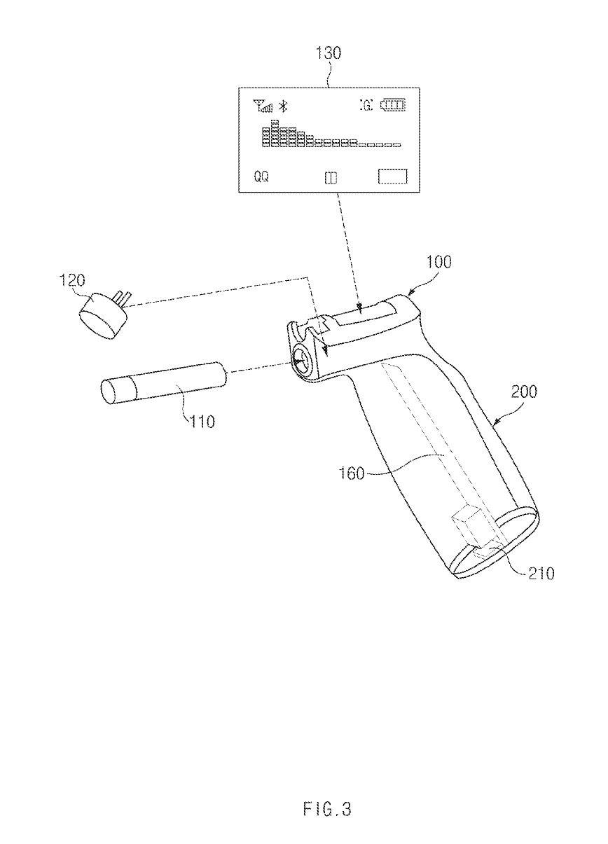

A portable noise measuring device according to an exemplary embodiment of the present disclosure is configured to include a head part 110 formed outside a body part 100, a microphone 120 measuring noise, and an output part 130 displaying the measured noise, as illustrated in FIGS. 1 and 3.

As illustrated in FIGS. 1 and 3, the body part 100 is a case in which a microphone 120 and an output part 130 to be described below are provided.

Here, a predetermined area is formed on an upper surface of the body part 100 so that the output part 130, which is a display device, may be provided.

The head part 110 may have a bar shape having a predetermined length, and may be mounted on a front surface of the body part 100, and may apply a pressure to an external object.

Here, it is preferable that the head part 110 is formed of a flexible plastic material in order to prevent generation of damage to the external object or the head part 110 at the time of pressing the external object.

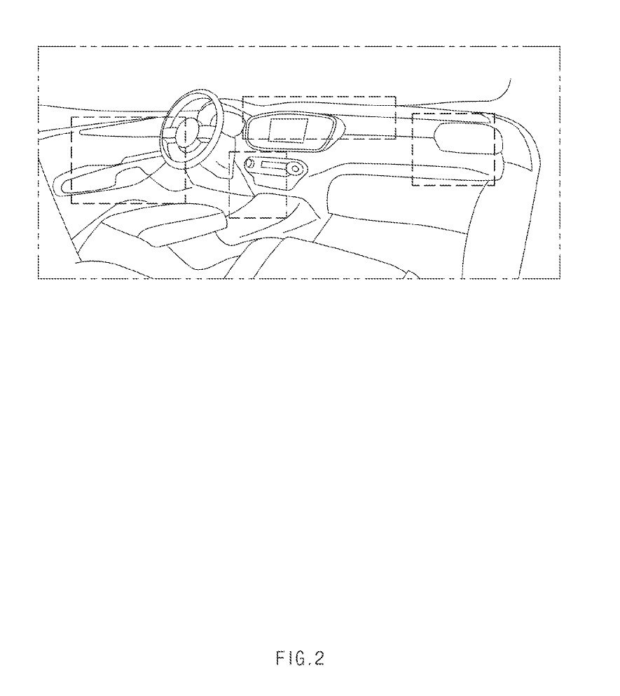

In the present disclosure, the external object is a component assembled to and mounted in a vehicle as illustrated in FIG. 2, and the component of the vehicle is a basic measurement target, but the present disclosure may also be applied to another object other than the vehicle depending on an application field.

In addition, the head part 110 may be provided to be detachable from the body part 100, such that it may be replaced at the time of occurrence of a problem.

The microphone 120 is a component measuring noise, which corresponds to a feature of the present disclosure, and is mounted inside the body part 100.

The microphone 120 may interwork with the head part 110 to allow noise generated at the time of pressing the external object through the head part 110 to be measured, and allow reference noise to be preset, thereby deciding whether or not the measured noise exceeds the reference noise.

The output part 130 interworks with the microphone 120, is mounted on the upper surface of the body part 100, and displays a level of the noise measured from the microphone 120 and whether or not the external object is successfully assembled when the measured noise exceeds the reference noise.

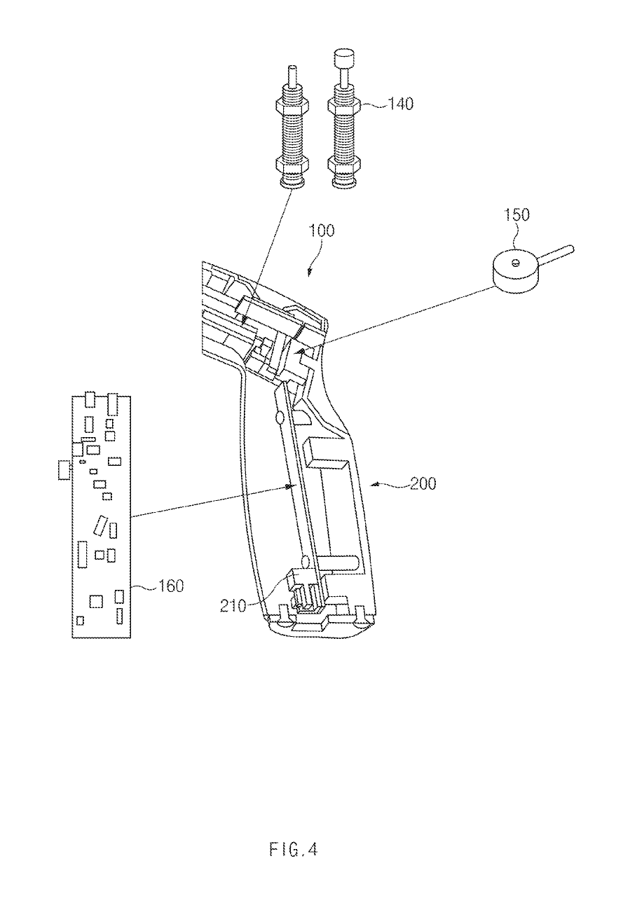

As illustrated in FIG. 4, the body part 100 includes a shock absorber 140 interworking with the head part 110 to absorb shock generated at the time of pressing the external object through the head part 110.

In addition, the body part 100 includes a load cell 150 interworking with the shock absorber 140 to measure a pressure depending on a pressing level of the external object.

The load cell 150 interworks with the output part 130 to allow the measured pressure to be displayed together with a level of noise on the output part 130.

That is, in the present disclosure, the noise generated at the time of pressing the external object through the head part 110 is measured through the microphone 120, and a level of the measured noise is displayed on the output part 130, thereby making it possible to allow a worker to confirm the level of the noise, and the pressure generated at the time of pressing the external object is also displayed on the output part 130 through the shock absorber 140 and the load cell 150, thereby making it possible to allow the worker to confirm the pressure applied to the external object as well as the noise.

In addition, an integrated board 160 interworking with the load cell 150 and the microphone 120 may be provided and may store the measured noise and the measured pressure therein.

Furthermore, the body part 100 may include a handle 200 formed in a downward direction and having a knob shape to facilitate handling of the portable noise measuring device according to the present exemplary embodiment at the time of measuring noise of components mounted inside and outside the vehicle, thereby making it possible to improve convenience of work.

Here, the integrated board 160 may be provided in the handle 200, and a connector 210 may be formed at a lower portion of the handle 200 to allow the integrated board 160 to be connected to an external computer.

That is, in the present disclosure, when the portable noise measuring device is connected to the external computer through the connector 210, the level of the measured noise and the pressure generated at the time of pressing the external object may be confirmed through the external computer, and the noise and the pressure stored in the integrated board 160 may also be confirmed.

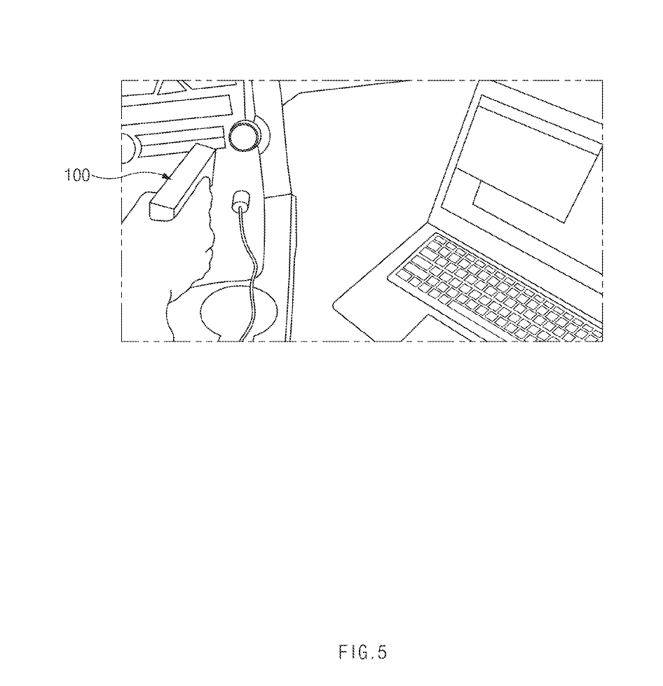

Furthermore, separate software may be installed in the computer so as to confirm the noise and the pressure measured in the portable noise measuring device to improve convenience of work, as illustrated in FIG. 5.

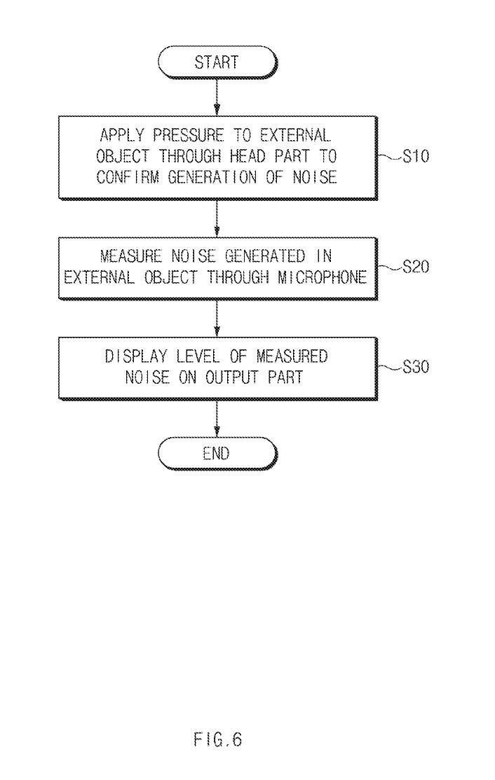

In addition, a noise measuring method according to an exemplary embodiment of the present disclosure includes a first step (S10) of applying the pressure to the external object through the head part 110 formed outside the body part 100, a second step (S20) of measuring the noise through the microphone 120, and a third step (S30) of displaying the measured noise through the output part 130, as illustrated in FIG. 6. Here, a configuration associated with the portable noise measuring device has been described with reference FIGS. 1 to 5.

In the first step (S10), which is a step of confirming the noise generated in the external object, the pressure is applied to the external object through the head part 110 of the body part 100 to confirm the generation of the noise in the external object.

In the second step (S20), which is a step of measuring the noise, the noise generated in the external object is measured through the microphone 120 provided in the body part 100 after the first step (S10).

In the third step (S30), which is a step of displaying the measured noise on the body part 100, the level of the noise measured from the microphone 120 is displayed on the output part 130 of the body part 100 after the second step (S20).

In the third step (S30), the body part 100 is connected to the external computer through the connector 210 to enable the level of the noise measured from the microphone 120 to be confirmed on the computer.

As described above, the portable noise measuring device according to an exemplary embodiment of the present disclosure includes the head part 110 mounted at a front end of the body part 100 and capable of applying pressure to the external object, the microphone 120 mounted inside the body part 100 and configured to measure the noise, and the output part 130 mounted outside the body part 100 and displaying the level of the noise measured from the microphone 120. The portable noise measuring device has easy portability, thereby increasing salability, and enables objective evaluation for the noise generated in the components mounted inside and outside the vehicle, thereby improving reliability of noise inspection and reducing the time and cost related to noise measurement.

As described above, the portable noise measuring device according to an exemplary embodiment of the present disclosure enables objective evaluation for noise generated in components mounted inside and outside a vehicle, thereby improving reliability of noise inspection, and reducing a time and a cost depending on noise measurement, thereby increasing convenience of work and salability.

Although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A portable noise measuring device comprising:
a head part disposed at a front end of a body part and applying a pressure to an external object;
a microphone disposed inside the body part and measuring noise; and
an output part mounted on an outside surface of the body part and displaying a level of the noise measured by the microphone.

2. The portable noise measuring device according to claim 1, wherein the microphone interworks with the head part such that the microphone measures the noise generated when the head part applies the pressure to the external object.

3. The portable noise measuring device according to claim 1, wherein the body part includes a shock absorber interworking with the head part to absorb shock generated when the head part applies the pressure to the external object.

4. The portable noise measuring device according to claim 3, wherein the body part includes a load cell interworking with the shock absorber to measure a pressure depending on a pressing level of the external object.

5. The portable noise measuring device according to claim 4, wherein the load cell interworks with the output part such that the measured pressure is displayed on the output part.

6. The portable noise measuring device according to claim 4, wherein an integrated board interworks with the load cell and the microphone to store a measured history therein.

7. The portable noise measuring device according to claim 6, wherein the body part includes a handle formed in a downward direction and having a knob shape.

8. The portable noise measuring device according to claim 7, wherein the integrated board is provided in the handle, and a connector is formed at a lower portion of the handle to connect the integrated board to an external computer.

9. The portable noise measuring device according to claim 1, wherein the head part is provided to be detachable from the body part.

10. The portable noise measuring device according to claim 1, wherein the head part is formed of a flexible plastic material.

11. A noise measuring method comprising steps of:
a first step of applying a pressure to an external object through a head part of a body part;
a second step of measuring the noise generated in the external object through a microphone provided in the body part when the head part applies the pressure to the external object; and
a third step of displaying a level of the noise measured by the microphone on an output part of the body part.

12. The noise measuring method according to claim 11, wherein, in the third step, the body part is connected to an external computer through a connector to allow the level of the noise measured by the microphone to be confirmed by the external computer.
